(19) United States
(12) Patent Application Publication
(10) Pub. No.: US 2019/0260144 A1
(43) Pub. Date: Aug. 22, 2019

(54) CONTACTING DEVICE

(71) Applicant: PSZ electronics Gmbh, Vohenstraub (DE)

(72) Inventor: Klaus Pfeiffer-Wagner, Weiden (DE)

(21) Appl. No.: 16/266,398

(22) Filed: Feb. 4, 2019

(30) Foreign Application Priority Data
Feb. 19, 2018 (DE) 10 2018 103 666.3

(51) Int. Cl. H01R 4/48; H01R 41/00

(52) U.S. Cl. CPC H01R 4/48; H01R 41/00

(57) ABSTRACT

A fastening clamp element for fastening and arranging pipe, hose or jacketed lines is provided. The fastening clamp element may include at least a gripping body such that the element can be fastened to the pipe, hose of jacketed line; and at least one assembly body that includes at least one fastening means. The assembly body may further have an assembly base body and an assembly contact layer, in which the assembly contact layer is at least partially comprised of material that is softer, on a Shore D scale, that the assembly base body. In some embodiments, the assembly base is in the form of an elongate assembly clamp flank, while in other embodiments, the element may have a double channel system formed of individual opposed partial channels.

### CROSS-REFERENCE TO RELATED APPLICATIONS

This application claim priority to German patent application 10 2018 103 666.3, filed Feb. 19, 2018, which is incorporated as if fully rewritten herein.

### STATEMENT REGARDING FEDERALLY SPONSORED RESEARCH OR DEVELOPMENT

Not applicable.

### TECHNICAL FIELD

The present disclosure relates generally to a fastening clamp element for fastening and arranging pipe, hose, jacketed lines and similar structures.

Illustrative examples of various embodiments of the invention, all provided by way of example and not limitation, are described.

### BRIEF DESCRIPTION OF THE ILLUSTRATIONS

Without limiting the scope of the as disclosed herein and referring now to the drawings and figures:

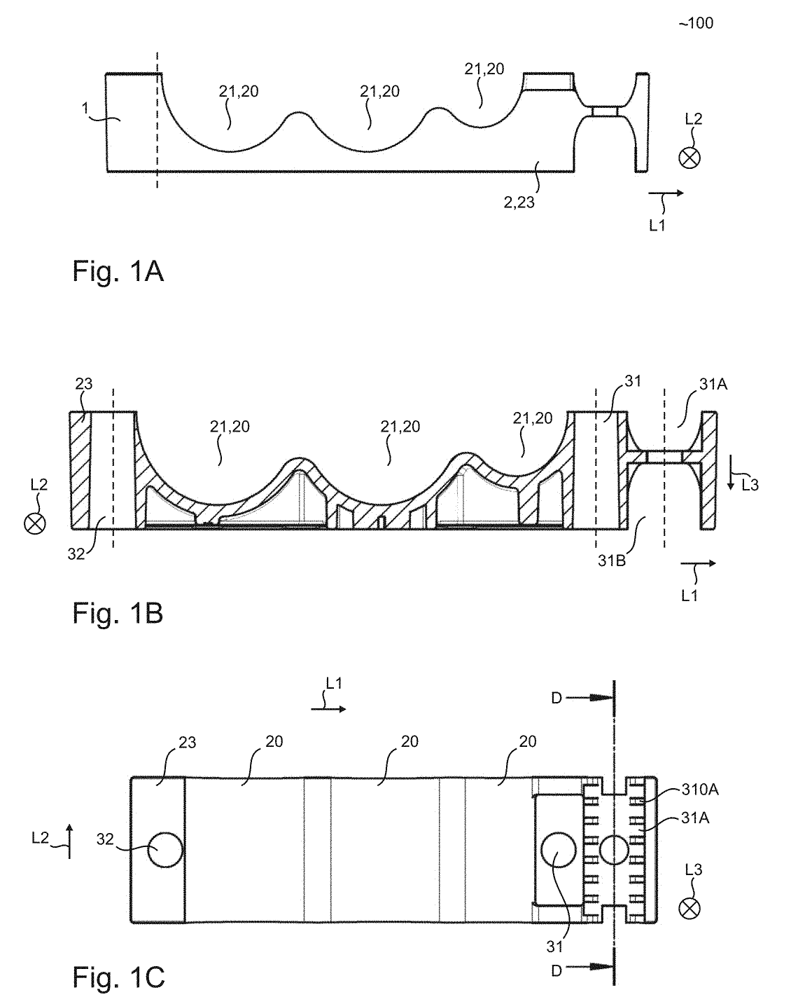

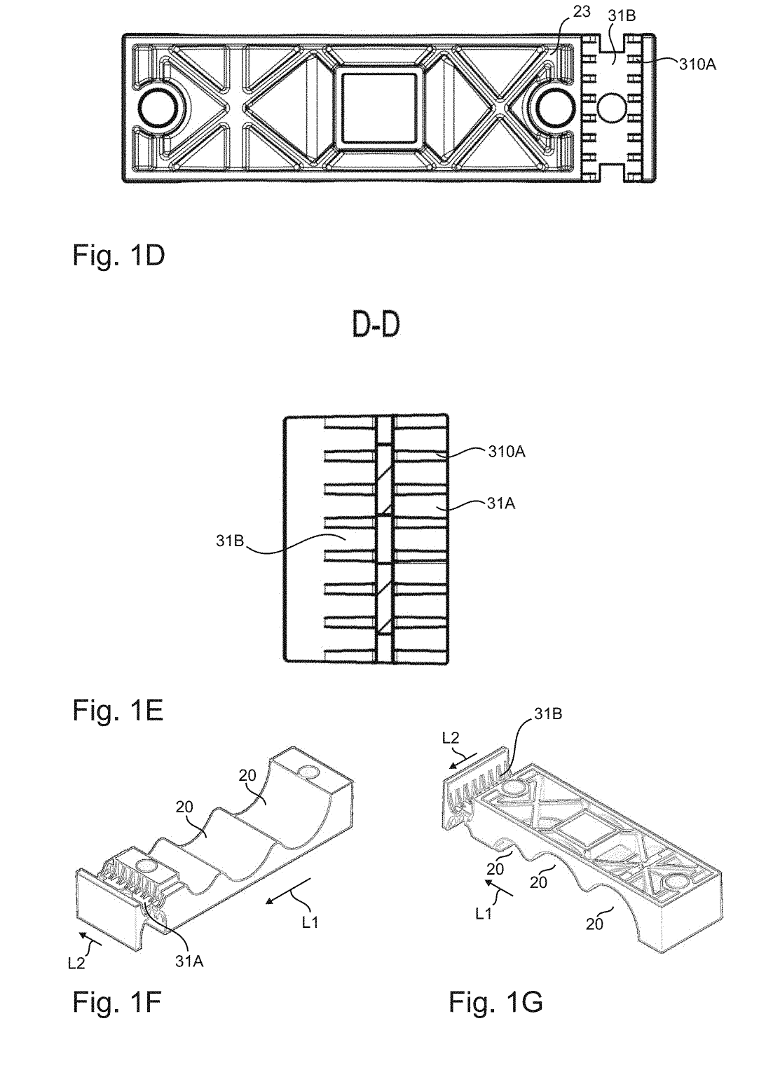

FIG. 1 a side view of an embodiment of the instant invention;

FIG. 1B is a side view of another embodiment of the instant invention;

FIG. 1C is a top view of an embodiment of the instant invention;

FIG. 1D is a top view of another embodiment of the instant invention;

FIG. 1E is a detail view of another embodiment of the instant invention;

FIG. 1F is an elevated perspective view of a portion of an embodiment of the instant invention;

FIG. 1G is an elevated perspective view of another portion of an embodiment of the instant invention;

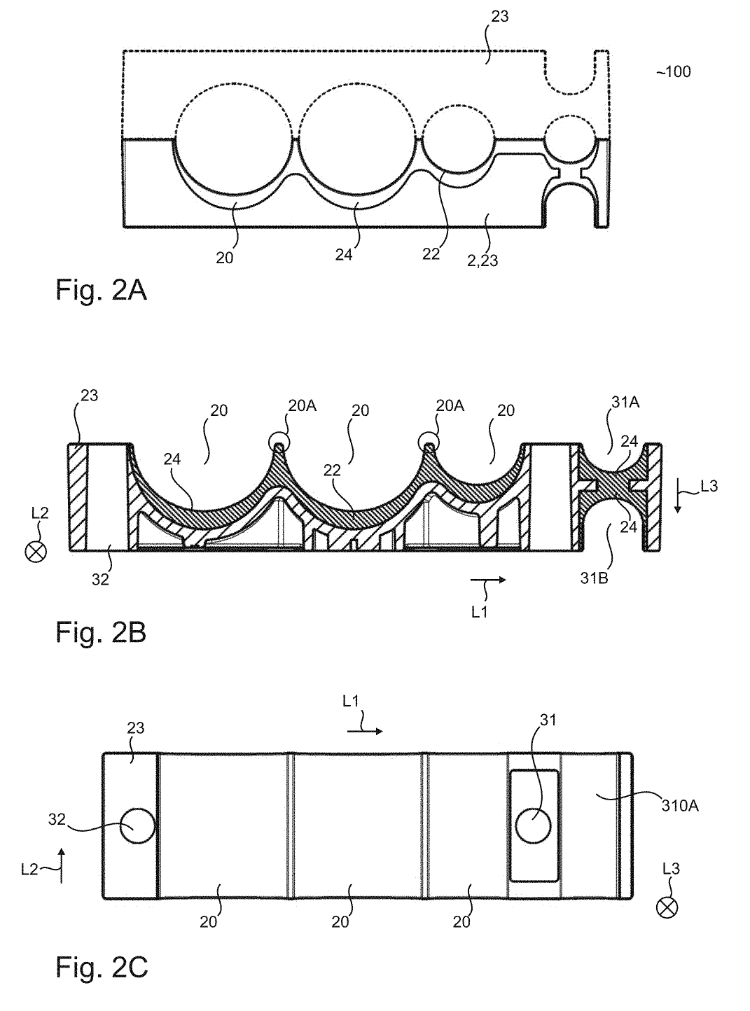

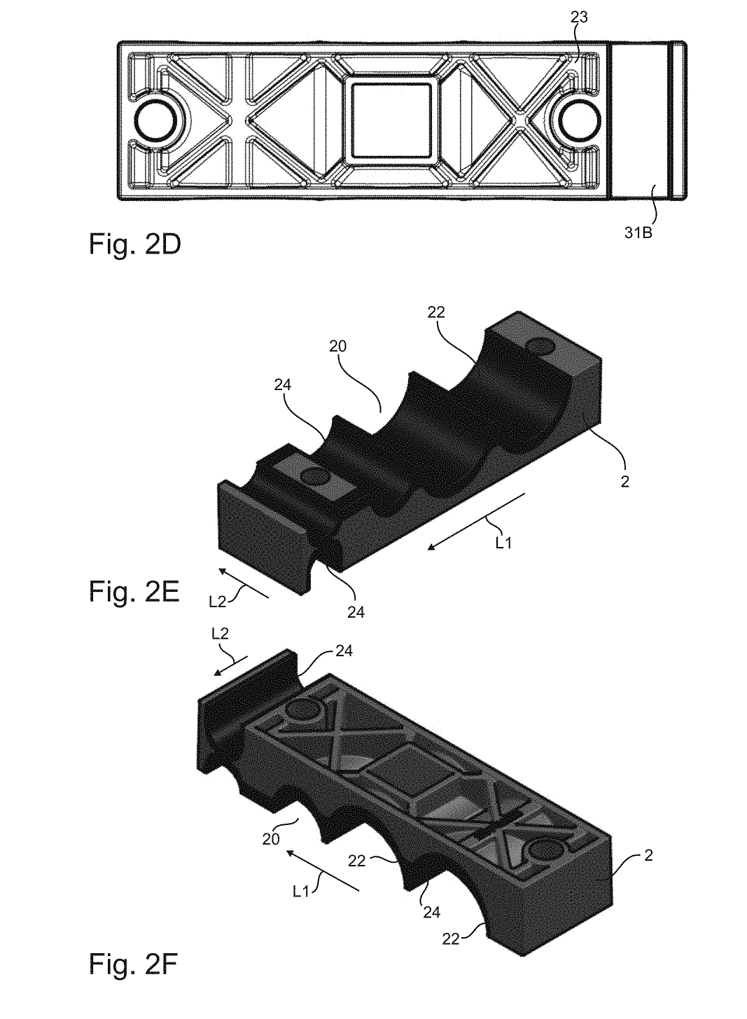

FIG. 2A is a side view of another embodiment of the instant invention;

FIG. 2B is a side view of a portion of another embodiment of the instant invention;

FIG. 2C is a top view of another embodiment of the instant invention;

FIG. 2D is a top view of another embodiment of the instant invention;

FIG. 2E is an elevated perspective view of a portion of an embodiment of the instant invention; and

FIG. 2F is an elevated perspective view of another portion of an embodiment of the instant invention.

These illustrations are provided to assist in the understanding of the exemplary embodiments of a contacting device and materials related thereto described in more detail below and should not be construed as unduly limiting the specification. In particular, the relative spacing, positioning, sizing and dimensions of the various elements illustrated in the drawings may not be drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The invention is described below in more detail with reference to FIGS. 1A-2F.

The present invention relates to a fastening clamp element for fastening and arranging pipe, hose or jacketed lines.

In particular, at least two pipe, hose or jacketed lines can be fastened to and/or on one another by means of the fastening clamp element proposed herein. Such pipe, hose or jacketed lines can also be fastened to walls or other pipe, hose or jacketed lines by means of the fastening clamp element described herein.

In vehicles in the field of specialized mobility (excavators, road rollers, cranes, forklifts, loaders, etc.), for example, diverse pipe, hose or jacketed lines (electrics, pneumatics, hydraulics) have to be fastened to the body.

Traditional fastening clamps squeeze these lines or do not fix them in position satisfactorily, as lines are subject to heavy tolerance.

In addition, the diameter of the pipe, hose or jacketed lines (e.g. pumping hydraulic lines) may change significantly during operation of the equipment.

On the other hand, the pipe, hose or jacketed lines should be able to move axially in the fastening clamps.

Hitherto, additional inserts were inserted into the fastening clamps. However, these additional inserts are pushed out of their position in the event of mechanical load by means of the pipe, hose or jacketed lines. A clamp of this kind therefore could not be used.

Fastening clamp elements of this kind known from the prior art comprise at least one gripping body, the gripping body being designed and provided such that the fastening clamp element can be fastened to the pipe, hose or jacketed lines by gripping the gripping body, in particular manually.

In addition, traditional fastening clamp elements of this kind comprise at least one assembly body, the assembly body comprising at least one fastening means on an inner assembly surface or the fastening means forming, at least in part, the inner assembly surface, whereby the pipe, hose or jacketed lines can be arranged on, in particular fastened to, the fastening clamp element.

The gripping body and/or the assembly base body may be produced integrally, for example within the context of a casting process. For example, the gripping body is arranged at the side of the assembly body. The gripping body is preferably free of fastening means for installing the pipe or hose lines. In particular, the gripping body and/or assembly base body may be free from any joining seams.

It is conceivable that a maximum thickness of the gripping body corresponds to a maximum thickness of the assembly base body. For example, the assembly base body is made of a single material. It is conceivable that the gripping body is made of the same material as the assembly base body.

In order to solve the above-mentioned problem, the present invention utilises utilizes inter alia the concept that the assembly body has an assembly base body, an assembly contact layer being applied, at least in parts, to at least one outer surface of the assembly base body, the assembly contact layer forming the inner assembly surface at least in parts, and furthermore the assembly contact layer having another material which is softer, in particular on a Shore D scale, than the assembly base body.

The softer assembly contact layer is therefore used firstly as tolerance compensation and secondly for installing the pipe or hose lines, in particular movably. This is partly because the assembly contact layer cannot be pushed out of its position relative to the assembly base body, or at least not without causing destruction. In other words, the assembly contact layer cannot be removed from the assembly base body without causing destruction.

The thickness of the material contact layer is at least 1 mm to at most 2 cm. The thickness of the material contact layer may be constant wherever it is applied to the assembly base body. Alternatively, however, the thickness of the material contact layer may vary at different points on the assembly base body.

Preferably, the material contact layer completely the covers the fastening means. The material contact layer may be the outermost layer. This may mean that the material contact layer is the only layer that comes into direct contact with the pipe, hose or jacketed lines.

It is also conceivable that the material contact layer consists or is formed of at least two sub-layers arranged one above the other. This may mean that although each material of these sub-layers is softer than the material of the assembly base body, the two sub-layers become softer in the direction of the pipe or hose lines. It is therefore conceivable that the layer directly applied to the assembly main body has a softer Shore D value than the material of the assembly base body, but has a harder Shore D value than the second sub-layer applied to the first sub-layer. This second sub-layer would therefore be in direct contact with the pipe or hose lines. In this respect, the material contact layer may be formed having material sub-layers placed on top of one another.

Moreover, it is conceivable that the second sub-layer has an in particular maximum thickness which is at least 20%, preferably at least 50%, smaller than the corresponding thickness of the first sub-layer. This may mean that the second sub-layer is formed in the manner of a closing or sealing layer.

For example, the material contact layer, or at least one sub-layer, has a gradient porosity. The porosity can therefore increase or decrease in the direction of the inner assembly surface starting from the material base body. Porosity is a dimensionless measured value and represents the ratio of void volume to total volume of a material or material mixture. It serves as a classifying measure for the voids that are actually present.

For example, only the first sub-layer has a porosity of this kind, whereas the second sub-layer closes off and seals the porous first sub-layer outwards.

A plurality of additional bodies, in particular substantially spherical bodies such as microglass bodies, can be incorporated at least in portions into the material contact layer (or at least into a sub-layer thereof). In this way, the mechanical load capacity is increased and the friction coefficient is severely reduced. The pipe or hose lines guided along the fastening clamp element can therefore be guided to the clamp itself with the lowest possible frictional resistance.

It is therefore possible that the surface structure of the material is formed by or comprises a plurality of spherical elements which are embedded in a base and/or carrier material of the guide device or of a guide insert. Advantageously, in this case these elements, in particular spherical elements, are made of a material which is selected from a group of materials. This includes glass or ceramic balls and the like, although preferably unipolar fillers.

Advantageously, these additional bodies, for example spherical bodies, each have a cross section or volume which has a diameter of less than 1 mm, preferably less than 0.1 mm and particularly preferably less than 0.01 mm.

Advantageously, a weight proportion of these spherical bodies with respect to the total material is more than 5%, preferably more than 10% and particularly preferably more than 20%.

Instead of spherical bodies, substantially spherical bodies, for example elliptical bodies, can be provided.

According to at least one embodiment, the fastening clamp element for fastening and arranging pipe, hose or jacketed lines comprises at least one gripping body, the gripping body being designed and provided such that the fastening clamp element can be fastened to the pipe, hose or jacketed lines by gripping the gripping body, in particular manually, and at least one assembly body, the assembly body comprising at least one fastening means on an inner assembly surface, by means of which surface can be arranged, in particular fastened, on the fastening clamp element.

According to the invention, the assembly body has an assembly base body, an assembly contact layer being applied, at least in parts, to at least one outer surface of the assembly base body, the assembly contact layer forming the inner assembly surface at least in parts and furthermore the assembly contact layer having another material which is softer, in particular on a Shore D scale, than the assembly base body.

For example, parts or entire assembly base bodies and/or the entire gripping body are produced using a 3D printing method.

In addition, it is conceivable that the assembly base body and/or the gripping body is formed of at least partially or completely inorganic parts, in the micrometer or nanometer range. Specifically, it has been found that nanoparticles of this kind inter alia ensure high strength of the assembly base body.

As shown in the non-exhaustive list below, the following 3D-printing technologies are suitable:

### 1. FDM Method (Fused Deposition Modelling)

Alternative names: Fused filament fabrication (FFF), fused layer modelling (FLM)

The method refers to applying (extruding) a material in layers by means of a hot nozzle. The consumable material is located, in the form of a long wire (filament), on a roller and is, by means of the conveying unit, moved into a print head, melted there and applied to a printing bed. The print head and/or printing bed are movable in three directions in this case. Plastics layers can thus be gradually applied to one another.

### 2. SLS Method (Selective Laser Sintering)

In contrast to the sintering method, in which materials are bonded to one another in powder form under the action of heat, in the SLS method this takes place selectively by means of a laser (alternatively an electron beam or an infrared beam). Therefore, only a specific part of the powder is melted together.

For this purpose, a thin powder layer is always applied to the printing bed by the coating unit. The laser (or another energy source) is then directed precisely to individual points of the powder layer in order to form the first layer of the print data. In this process, the powder is melted or fused and is then solidified again by slight cooling. The unmelted powder remains around the sintered regions and is used as supporting material. After a layer is solidified, the printing bed is lowered by a fraction of a millimeter. The layering unit moves over the printing bed and applies the next powder layer. Subsequently, the second layer of the print data is sintered by the laser (or another energy source). This produces a three-dimensional object in layers.

### 3. Three-Dimensional Printing (3DP)

The 3DP method functions very similarly to selective laser sintering, but instead of a directed energy source, a print head travels over the powder. This print head deposits tiny droplets of a binding agent onto the underlying powder layers, which are thus bonded to one another. Otherwise, this method is identical to the SLS method.

### 4. Stereolithography (SLA)

Instead of a plastics wire or printing material in powder form, in the stereolithography method liquid resins, known as photopolymers, are used. These resins are hardened in layers by UV radiation and thus produce three-dimensional objects. For this purpose, the build platform is gradually lowered in the resin tank. There are also variants (so-called polyjet methods) without an entire tank of liquid resin. For this purpose, an epoxy resin is applied in droplets out of a nozzle and is immediately cured by a UV laser.

### 5. Laminated Object Manufacturing (LOM)

Alternative name: Layer laminated manufacturing (LLM)

The method is based neither on chemical reactions nor on a thermal process. Here, a film or plate (e.g. paper) is cut along the contour by means of a separating tool (e.g. a knife or carbon dioxide laser) and the parts are bonded together in layers. The lowering of the build platform therefore produces a layered object made of bonded films lying one on top of the other.

According to at least one embodiment, the assembly contact layer is sprayed onto the assembly base body at least in parts.

According to at least one embodiment, the assembly contact layer is bonded to the assembly base body at least in parts.

According to at least one embodiment, the assembly contact layer is made of a plastics material.

For example, the assembly base body and the assembly contact layer are formed together within the context of 2-component casting.

The assembly base body and/or the material contact layer (or at least a sub-layer thereof) may be made of a plastics material which is selected from a group containing polyethylene (PE), polyether ether ketones (PEEK), polyoxymethylene (POM), and in particular ultra-high-molecular-weight polyethylene (UHMWPE), PP (polypropylene), PA (polyamide)—in particular PA46, PA6, PA6.6, PA11 or PA12, —PBT (polybutylene phthalate), PMP (polymethylpentene) and the like. In addition, combinations of these materials can also be used. In this case, the plastics materials mentioned are in part examples of plastics materials that can be crosslinked by radiation.

In principle, the following non-exhaustive list shows possible materials for the assembly base body and the material contact layer:

| Material group | Modification | Shore D |
|---|---|---|
| ABS | | 75-93 |
| | ABS + 30 wt. % GF | 62-68 |
| | ABS/TPE | 46 |
| | ABS/TPU | 58-68 |
| ASA | | 75 |
| ETFE | | 60-78 |
| EVA | | 17-45 |
| PA 11 | PA 11 + 23 wt. % GF | 70 |
| PA 12 | PA 12 (moist as standard) | 75-78 |
| | PA 12 + 30 wt. % GF (moist as standard) | 75 |
| PA 612 | | 73 |
| PA 6 | PA 6 (moist as standard) | 52-77 |
| | PA 6 + 30 wt. % GF | 48-80 |
| | PA 6 + 30 wt. % GF (dry) | 84 |
| PA 66 | PA 66 + 30 wt. % GF | 77-82 |
| | PA 66 + 30 wt. % GB | 81 |
| | PA 66 + 30 wt. % MX | 75-82 |
| PAEK | | 86-90 |
| | PAEK + 30 wt. % GF | 90 |
| PBI | | 99 |
| PBT | | 79-86 |
| | PBT + 30 wt. % GF | 53-85 |
| | PBT + 30 wt. % GX | 54 |
| PC | | 51-85 |
| | PC + 30 wt. % GF | 65-72 |
| | PC + 30 wt. % GX | 70 |
| PCTFE | | 76-80 |
| PE-HD | | 56-69 |
| PE-LD | | 39-83 |
| PE-LLD | | 38-60 |
| PE-MD | | 45-60 |
| PE-UHMW | | 60-65 |
| PEEK | | 83-88 |
| PEI | | 88-90 |
| PEK | | 87 |
| | PEK + 30 wt. % GF | 90 |
| PET | PET + 30 wt. % GF | 63-65 |
| PMMA | | 52-85 |
| | PMMA + 30 wt. % GF | 55 |
| POM | | 52-83 |
| PP | | 59-77 |
| | PP + 30 wt. % GF | 62-80 |
| | PP + 30 wt. % CD | 74-75 |
| | PP + 30 wt. % MF | 60-74 |
| | PP + 30 wt. % P | 65 |
| | PP + 30 wt. % CaCO3 | 55-70 |
| | PP/EPDM | 40 |
| PS | | 78-80 |
| PTFE | | 50-90 |
| PUR | | 20-84 |
| PVC-U | | 74-94 |
| | PVC-U/NBR | 58-74 |
| PVC-P | | 42-77 |
| PVC-C | | 82 |
| PVDF | | 46-79 |
| SAN | | 45-85 |
| SMMA | | 72-82 |
| TPC | | 28-82 |
| TPE | | 48-78 |
| | TPE/PTFE | 56 |
| TPE-E | TPE-E + 30 wt. % GF | 55 |
| TPO | | 16-70 |
| TPS | | 60 |
| TPU | TPU + 30 wt. % GF | 74-80 |
| TPV | | 40-51 |

where:
GF = glass fibers
GB = glass balls
MF = mineral fibres fibers
MX = unspecified mineral filling
GX = unspecified glass filling
CD = carbon powder
P = unspecified filling powder

For example, the assembly base body is made of the material PA6 (a hard plastics material), the material contact layer being made of a softer material, i.e. TPE for example.

In another advantageous embodiment, another component is added to the plastics material in order to stimulate crosslinking. Advantageously, this additional component is added to a resin. Advantageously, this additional component is a crosslinking promoter. Preferably, the plastics materials PA or PBT can be crosslinked in this case.

The degree of crosslinking (also known as gel content) can be used to demonstrate crosslinking. This gel content is determined in accordance with DIN 16892/120 by boiling over several hours in a suitable solvent (e.g. formic acid). In this case, it is gravimetrically determined how great the mass of the crosslinked material is in relation to the total mass. A soldering iron test according to PTS specifications is also conventional for practical rapid tests. Advantageously, the gel content or the degree of crosslinking is above 10%, preferably above 30%, and particularly preferably over 50%.

According to at least one embodiment, the assembly base body is made of a plastics material.

According to at least one embodiment, a Shore D hardness value of the assembly base body is greater than a Shore D hardness value of the assembly contact layer by at least two, preferably by at least four, hardness values.

According to at least one embodiment, the assembly body is formed as an elongate assembly clamp flank, the fastening means comprising recesses in the assembly body or are recesses of this kind, the recesses being designed and provided such that the pipe, hose or jacketed lines are arranged along the outside of such recesses, the pipe, hose or jacketed lines being in direct mechanical contact with the assembly body preferably only in those recesses.

According to at least one embodiment, the recesses are cylindrical segment-shaped and extend in a direction that is perpendicular to the main direction of extent (L1 direction) of the assembly body.

It is conceivable that the thickness of the assembly contact layer (i.e. the length dimension in an L3 direction; see drawings) varies along the recesses, in particular in the L1 direction. This may mean that the assembly contact layer (in the main direction of extent of the assembly base body) is applied to or arranged on the assembly base body in different thicknesses. For this purpose, it is conceivable that inside a recess, the thickness of the assembly contact layer increases or decreases starting from an edge of the recess towards the center of the recess in the L1 direction. An increase in thickness of the assembly contact layer in the center point of the recess may be at least 20% and at most 100%, compared to an edge point of the recess. Specifically, it has been recognized that the largest motion and force compensation takes place in the center of each recess to compensate for movement and to stabilize the pipe or hose lines in the recess, while this size can decrease towards the edge of each recess.

Conversely, it is also possible that a decrease in thickness of the assembly contact layer in the center point of the recess may be at least 20% and at most 100%, compared to an edge point of the recess.

The variation of the thickness of the material contact layer can have the effect that while a recess in the main direction of extent of the assembly main body has a circular shape, for example, the assembly inner surface, which is formed by the assembly contact layer, assumes a shape that is different therefrom. The assembly inner surface can therefore assume an ellipsoidal shape, whereas the recess follows a circular shape.

According to at least one embodiment, at least one mounting hole is arranged next to the recesses in each case in the main direction of extent, the mounting hole extending completely through the assembly base body in an L3 direction that is perpendicular to both the L1 direction and the L2 direction.

According to at least one embodiment, in the main direction of extent, a double channel system is arranged next to the through-hole, which system is formed such that it comprises two partial channels facing away from one another and each opening to the outside, the individual partial channels therefore extending in parallel with the recesses, but being spatially separated from such recesses by a mounting hole.

Preferably, the recesses are formed as a cylindrical segment or form at least part thereof. Recesses of this kind each have a symmetrical axis. The above-mentioned partial channels may extend in parallel with at least one symmetrical axis.

In this case, the recesses may each have a recess radius of a constant or variable size. The recesses preferably open to the outside in parts. A radius of at least one recess in the material main body may be at least 1 cm and at most 10 cm.

The invention is explained in greater detail in the following with reference to a second embodiment and the relevant drawings.

FIGS. 1A to 1G are each a schematic view of a first embodiment of a fastening clamp element described herein according to the invention.

FIGS. 2A to 2F are each schematic views of a second embodiment of a fastening clamp element described herein according to the invention having an additional assembly contact layer.

The shown drawings are each a schematically perspective view of the fastening clamp element presented herein.

In the drawings, like or analogous components are each provided with the same reference signs.

FIG. 1A is a schematic side view of an embodiment of a fastening clamp element 100 presented herein for fastening and arranging pipe, hose or jacketed lines.

A gripping body 1 can be seen which is arranged on the left of an assembly body 2. In the present case, the assembly body 2 is formed integrally with the gripping body 1 within the context of a single casting process. In this respect, therefore, neither seams nor gaps separate the gripping body 1 and the assembly body 2. The gripping body 1 is therefore, as shown from the side in FIG. 1A, in the form of a cuboid. However, other designs of the gripping body 1 are considered. For example, it is conceivable that the gripping body 1 has specific corrugations or holding aids for manually fastening the fastening clamp element 100 to the pipe or hose lines.

Furthermore, the fastening means 21 arranged in the assembly body 2, in each case in the form of recesses 20 incorporated into the assembly body 2, are shown in the side view according to FIG. 1A, the recesses 20 being designed and provided such that the pipe or hose lines are arranged and adapted along those recesses.

In particular, it can be seen that the recesses 20 are therefore designed to come into direct contact with the pipe or hose lines. In addition, it can be seen that the recesses 20 are cylindrical segment-shaped and extend in an L1 direction (the main direction of extent of the fastening clamp element 100). Starting from the gripping body 1 in the L1 direction, the recesses 20 therefore have radiuses that constantly decrease in each case.

In the present case, three recesses 20 arranged one behind the other in the direction L1 are provided, which recesses merge into one another by means of different connecting radiuses of the assembly body 2.

In particular, it should be mentioned that the assembly body 2 in FIGS. 1A to 1D also simultaneously comprises the assembly base body 23.

FIG. 1B is a sectional view of the assembly base body 23 shown in FIG. 1A.

In particular, it can be seen from the sectional view shown that in the L1 direction, the recesses 20 are each arranged on both sides of adjacent mounting holes 31, 32. The mounting holes 31, 32 extend through the assembly base body 23 in an L3 direction which is perpendicular to both the L1 direction and the L2 direction.

As is clear from FIG. 1B, a double channel system 31A, 31B is formed on the right next to the through-hole 31, which system is constructed such that it comprises two partial channels 31A, 31B facing away from one another and each opening to the outside, such that the double channel system 31A, 31B is in the form of an X. The individual channels 31A, 31B therefore extend in parallel with the recesses 20, but are spatially separated from the mounting holes 31.

Moreover, it can be seen from the schematic perspective plan view according to FIG. 1C that different corrugations, for example contact corrugations 310A, are arranged at least in the through-channel 31A in order to facilitate contact with a cable to be guided therethrough or even to make this possible at all.

FIG. 1D is a schematic bottom view in which it can be seen that the channel 31B and the channel 31A each have corresponding corrugations.

In this case, FIG. 1E is a schematic sectional view from the perspective D-D, as indicated schematically in FIG. 1C.

Moreover, FIGS. 1F and 1G each show schematically perspective views of the assembly base body 23 shown in FIGS. 1A to 1D.

Another example of a fastening clamp element 100 according to the invention is clear from FIGS. 2A and 2F, which example, in contrast to FIGS. 1A to 1G, shows the assembly contact layer 24 applied to the assembly base body 23.

It can be seen that the assembly contact layer 24 completely covers the recesses 20 and the channels 31A, 31B with a predeterminable layer thickness. However, this layer thickness is selected so as to not be constant in the L1 direction in the present embodiment. For example, it can be seen that the layer thickness of the assembly contact layer 24 is largest at the left-hand outer end of the largest recess 20, becomes smaller towards the center of the recess, and becomes larger again in further extension towards the center of the recess 20.

In addition, it can be seen from FIG. 2A that the present application discloses not only a single fastening clamp element 100, but additionally discloses a combination of two fastening clamp elements 100.

As shown specifically in FIG. 2A, only one fastening clamp element 100 comprises the assembly contact layer 24 according to the invention, whereas an additional assembly base body 23 (which is also a fastening clamp element 100 disclosed herein) placed congruently on top thereof is free of an assembly contact layer 24 of this kind.

This is partly because it has been recognized that the arrangement of only one assembly contact layer 24 can be sufficient to ensure satisfactory fixing during use.

However, it may also be conceivable that the above-described assembly contact layer 24 is also applied to this additional assembly base body 23 in the same way as it is applied to the assembly base body 23. Preferably, the two assembly base bodies 23 are identical and are therefore equal in every respect.

In summary, the assembly body 2 is formed having the assembly base body 23, an assembly contact layer 24 being applied, at least in parts, to at least one outer surface of the assembly base body 23, the assembly contact layer 24 forming an inner assembly surface 22 at least in parts, and furthermore the assembly contact layer 24 having another material that is softer, in particular on a Shore D scale, than the assembly base body 23.

FIG. 2B is a schematic side view of the fastening clamp 100 proposed according to the invention, it being clearly recognizable in turn that the material contact layer 24 is applied over the entire surface thereof at least in the recesses 20 and in the channels 31A and 31B. In addition, however, it can also be seen that separation flanks 20A are formed completely by the material layer 24 between each directly adjacent recess 20. This means that the material contact layer 24 preferably still has a degree of hardness such that the previously positioned pipe, hose or jacketed lines, preferably alone, are mechanically fixed by the material contact layer 24 in the direction L1 and can no longer slide back and forth in the direction L1.

The remaining FIGS. 2C to 2F show, in the same way as with regard to FIGS. 1C to 1F, the finished fastening clamp element 100 according to the invention described here and the applied material contact layer 24.

The invention is not restricted on the basis of the description and the embodiment; on the contrary, the invention encompasses each novel feature as well as any combination of features, in particular including any combination of claims, even if this feature or this combination itself is not explicitly mentioned in the claims or in the embodiment.

### LIST OF REFERENCE NUMERALS

1 gripping body
2 assembly body
20 recesses
20A separation flanks
21 fastening means
22 inner assembly surface
23 assembly base body
25 assembly contact layer
31 mounting hole
31A partial channel
31B partial channel
32 mounting hole
100 fastening clamp element
310A contact corrugations
L1 direction
L2 direction
L3 direction

1-10. (canceled)

11. A fastening clamp element (100) for fastening and arranging pipe, hose or jacketed lines, comprising
at least one gripping body (1), the gripping body (1) being designed and provided such that the fastening clamp element (100) can be fastened to the pipe, hose or jacketed lines by gripping the gripping body (1), in particular manually, and
at least one assembly body (2), the assembly body (2) comprising at least one fastening means (21) on an inner assembly surface (22), by means of which surface the pipe, hose or jacketed lines can be arranged, in particular fastened, on the fastening clamp element (100),
characterized in that the assembly body (2) is formed having an assembly base body (23), an assembly contact layer (24) being attached to at least one outer surface of the assembly base body (23), at least in parts, the assembly contact layer (24) forming, at least in parts, the inner assembly surface (22) and furthermore the assembly contact layer (24) having another material that is softer, in particular on a Shore D scale, than the assembly base body (23).

12. The fastening clamp element (100) according to claim 1, characterized in that the assembly contact layer (24) is sprayed onto the assembly base body (23) at least in parts.

13. The fastening clamp element (100) according to claim 1, characterized in that the assembly contact layer (24) is bonded to the assembly base body (23) at least in parts.

14. The fastening clamp element (100) according to claim 1, characterized in that the assembly contact layer (24) is made of a plastic material.

15. The fastening clamp element (100) according to claim 1, characterized in that the assembly base body (23) is made of a plastics material.

16. The fastening clamp element (100) according to claim 1, characterized in that a Shore D hardness value of the assembly base body (23) is greater than a Shore D hardness value of the assembly contact layer (24) by at least two, preferably by at least four, hardness values.

17. The fastening clamp element (100) according claim 1, characterized in that the assembly body (2) is in the form of an elongate assembly clamp flank, the fastening agent (21) comprising or being recesses (20) in the assembly body (2), the recesses (20) being designed and provided such that the pipe, hose or jacketed lines are arranged along the outside of such recesses, the pipe, hose or jacketed lines being in direct mechanical contact with the assembly body (2) preferably only in those recesses (20).

18. The fastening clamp element (100) according to claim 17, characterized in that the recesses (20) are cylindrical segment-shaped and extend in a direction (L2) that is perpendicular to the main direction of extent (L1) of the assembly body (2).

19. The fastening clamp element (100) according claim 18, characterized in that at least one mounting hole (31, 32) is arranged next to the recesses (20) in each case in the main direction of extent (L1), the mounting hole (31, 32) extending completely through the assembly base body (23) in an L3 direction that is perpendicular to both the L1 direction and the L2 direction.

20. The fastening clamp element (100) according to claim 19, characterized in that in the main direction of extent (L1), a double channel system (31A, 31B) is arranged next to the through-hole (31), which system is formed such that it comprises two partial channels (31A, 31B) facing away from one another and each opening to the outside, the individual partial channels (31A, 31B) therefore extending in parallel with the recesses (20), but being spatially separated from those recesses by a mounting hole (31, 32).
